(19) United States
(12) Patent Application Publication
(10) Pub. No.: US 2008/0077672 A1
(43) Pub. Date: Mar. 27, 2008

(54) Online messaging architecture

(75) Inventor: William Clayton Knight, Bainbridge Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Trumba Corporation, Seattle, WA (US)

(21) Appl. No.: 11/525,880

(22) Filed: Sep. 22, 2006

(51) Int. Cl. G06F 15/16

(52) U.S. Cl. 709/206

(57) ABSTRACT

Generally described, the present invention relates to a messaging architecture for an online service. More specifically, the present invention relates to a messaging architecture and processes that facilitate the processing of messages delivered by the online service over a variety of communication networks. The messages may be special-purpose messages, customized messages, and/or a high volume of messages.

### BACKGROUND

Generally described, computing devices and communication networks, such as the Internet, facilitate access to and use of information. The increasing availability of high-bandwidth communication networks has resulted in a corresponding growth in the number and variety of network-based services. In a typical embodiment, users of various network-based services commonly wish to exchange data with other users and applications. For example, a user may want to pass data generated or maintained by an online service to another user. Accordingly, many online services, such as Web-based news sources or e-commerce sites, offer users the ability to “send to a friend.” For the most part, this is accomplished by sending an email from the Web service. The body of the email generally contains either forwarded content (e.g., text and/or graphics) or the information can include an embedded hyperlink to the content accessible on the Web.

In the context of some online services, such as electronic invitation or event planning services, it may be desirable to send similar or identical information to multiple recipients. In this case, a distribution list of recipients can be created to send email from the online service. In one event planning scenario, each invitee of the event is provided with an electronic message that can include information associated with the event and an embedded hyperlink for accessing updateable content on a Web site, referred to as a Web document. The information may include links to additional online services. For example, an invitation corresponding to an event (such as a party) could, perhaps, provide a link to the mapping Web service for directions to the event as well as the descriptive information regarding the event (e.g., time, place, purpose). Additionally, the updatable Web document can reflect response information/comments from the recipients of an invitation. The responses can also be generally forwarded to an individual planning the event.

Generally described, the distribution of email messages from an online service typically relies upon an integrated mail component in a Web application to generate email messages and forward them directly to a simple mail transfer protocol (“SMTP”) agent. Typically, these types of email distribution approaches are limited in that they do not provide load balancing or failover support. Furthermore, the aforementioned information sharing systems are sufficient for only a limited class of transactions, such as forwarding a link or emailing a single document to a list of recipients. Such systems can become deficient for use in scenarios in which special purpose, customized, timed, or prioritized messages are to be generated by an online service. These systems can also become deficient if the email messages generated by an online service are to be transmitted over a variety of communication networks that utilize different systems and protocols. Still further, these systems can be deficient if a high volume of messages is to be generated by an online service.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A messaging architecture for an online service is provided. In one aspect of the invention, data generated by an application associated with the online service is packaged as a request and placed in a message request queue. In another aspect of the invention, data generated by the online application is either synchronously packaged as a request and placed in a message request queue or is entered as a database record that later (asynchronously) results in a request being placed in the message request queue. Message requests are classified, serialized, and prioritized for placement in the queue. In a further aspect of the invention, the message request is received by a request daemon that polls the message request queue for a new message request. The message daemon de-serializes the message request and, based upon the message request type, instantiates a corresponding message job object that is configured to satisfy the message request.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a block diagram of an online service architecture including a number of client computing devices and an online service in accordance with the present invention;

FIG. 1B is a block diagram of an online service architecture including software applications and resources in accordance with the present invention;

FIG. 2 is flow diagram of an illustrative message request processing routine implemented by the online service in accordance with an aspect of the present invention;

FIG. 3 is flow diagram of an illustrative message order processing routine implemented by the online service in accordance with an aspect of the present invention;

FIG. 4 is flow diagram of an illustrative message order processing routine implemented by the online service in accordance with a calendar digest illustration;

FIG. 5 is flow diagram of an illustrative message request processing routine implemented by the online service in accordance with a digital image management illustration; and

FIG. 6 is a flow diagram of an illustrative handling routine implemented by the online service in accordance with one aspect of the present invention.

### DETAILED DESCRIPTION

Generally described, the present invention relates to a messaging architecture for an online service. More specifically, the present invention relates to a messaging architecture and processes that facilitate the processing of messages delivered by an online service over a variety of communication networks. The messaging architecture is especially well-suited to receive and satisfy requests to send special purpose messages, customized messages, and/or high volume messages. While the present invention will be described with regard to various communication media and illustrative embodiments, one skilled in the relevant art will appreciate that the disclosed embodiments are illustrative in nature and should not be construed as limiting.

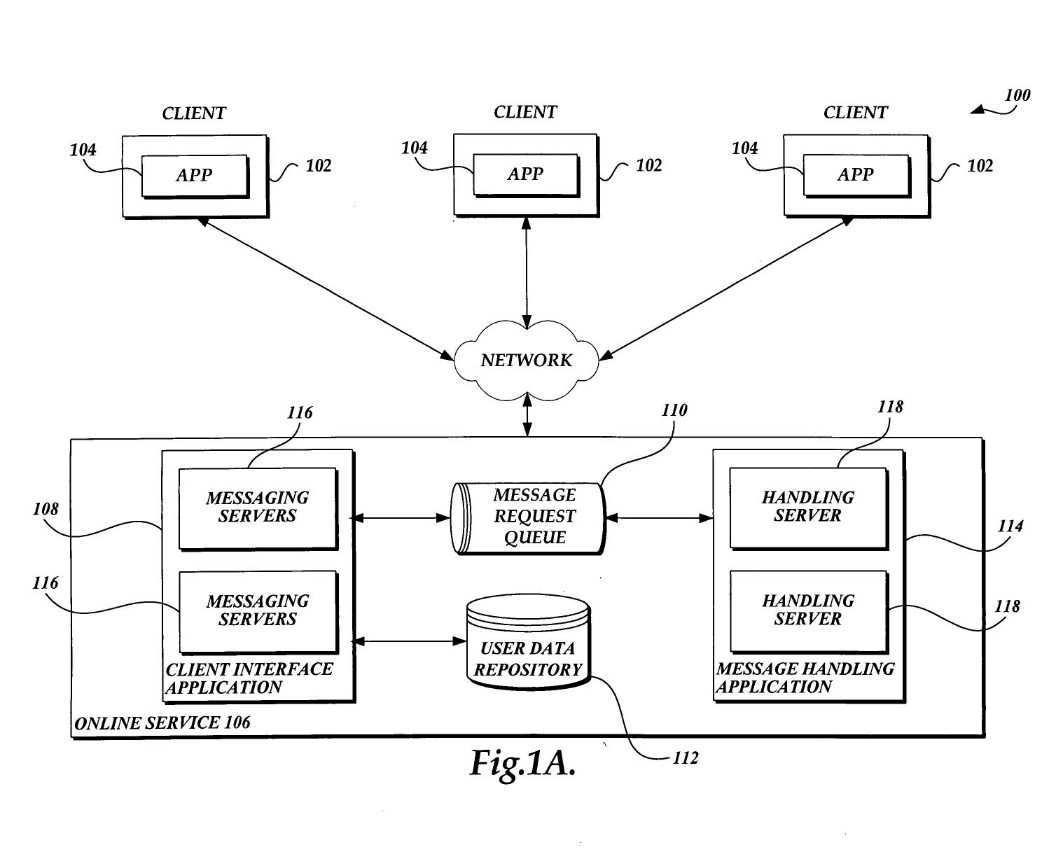

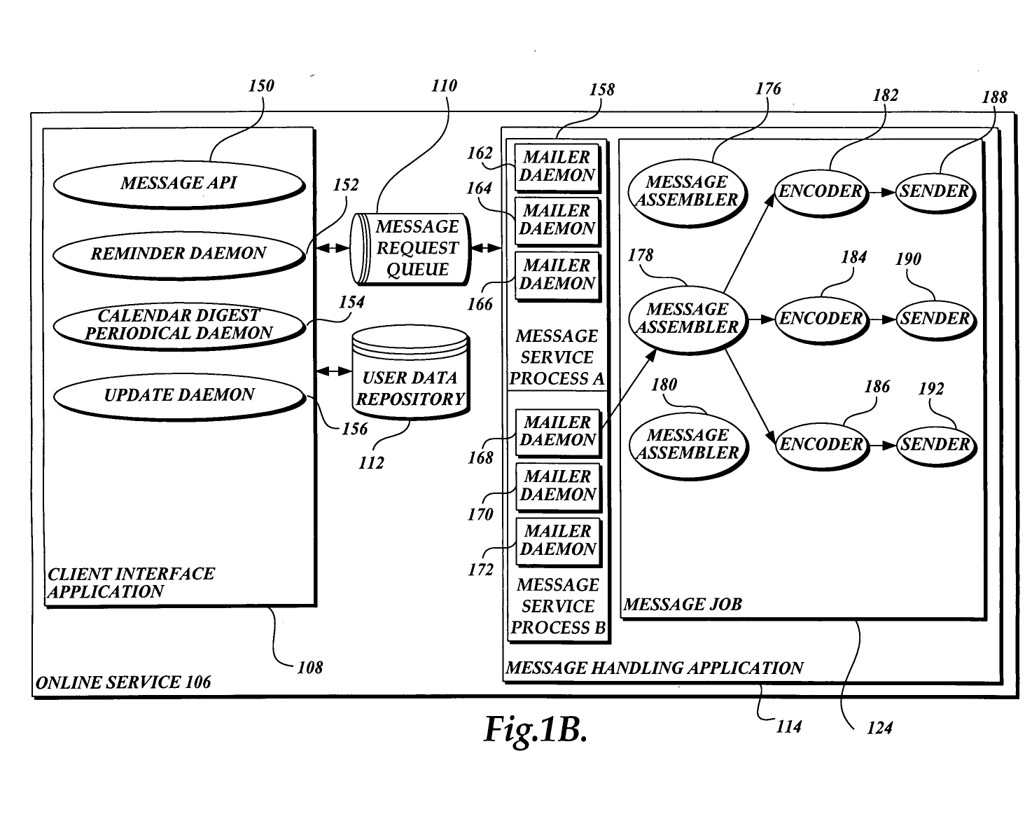

With reference to FIG. 1A, a block diagram of an illustrative architecture for an online communication network 100 is shown. The online communication network 100 includes a number of client computing devices 102 that include software applications for accessing a communication network, such as the Internet, instant messaging (IM) networks, text messaging networks, private communication networks, and the like. One skilled in the relevant art will appreciate that the above-referenced communication networks may differ according to communication and security protocols and/or physical media utilized to transmit data. In an illustrative embodiment of the present invention, the client computing devices 102 include, but are not limited to, personal computers, mobile computing devices, mobile telephones, hand-held computing devices, terminals, and the like. The client computing devices 102 can include one or more software applications 104 that facilitate communication via the various communication networks. For example, the software application 104 can include a browser-based software application that facilitates communication via the Internet and instant messaging communication networks. The software applications 104 can be dedicated communication software applications. Alternatively, the software applications 104 can include one or more software components for facilitating communication in addition to various other functionality.

The online communication network 100 can also include an online service 106 for processing requests and handling message delivery to and from the client computing devices 102. As illustrated in FIG. 1A, functionality implemented by the online service 106 and its associated components are distributed across multiple computing devices. Generally described and in accordance with one embodiment, the online service 106 includes a client interface application 108, a message request queue 110, a user data repository 112, and a message handling application 114.

Generally described, the client interface application 108 processes incoming client communications including requests associated with sending messages over the network 100. As described in further detail below with reference to FIG. 1B, the client interface application 108 can include a number of specialized components, such as daemons, for identifying different types of message requests that should be queued in the message request queue 110. In this regard, the message request queue 110 serves as a repository for received requests that will be satisfied by the message handling application 114. Also, the online service 106 further includes a user data repository 112 that includes user profiles for accessing data and additional data specific to the online service 106. In an illustrative embodiment of the present invention, the message request queue 110 and user data repository 112 may correspond to a number of database servers configured locally or distributed across a network.

As illustrated in FIG. 1A, the client interface application 108 is collectively distributed across the messaging servers 116. In one embodiment, the messaging servers 116 may include a number of servers, such as Web servers, email servers, and/or other communication devices that facilitate receipt of communications from the client computing devices 102 in a variety of communication media. In an illustrative embodiment, the messaging servers 116 can be arranged in a peer-to-peer networking environment such that each successive server is operable to replicate the functionality of the previous server. For example, server “one” is known to itself, server “two” knows itself and server “one” and server “three” know themselves as well as “one” and “two,” etc. In accordance with an embodiment, in the event that one of the messaging servers 116 is called upon to process a higher volume of communication requests or, in the event of a server failure, another server can take over all or at least a portion of another server's role in the online service 106.

With continued reference to FIG. 1A, the online service 106 further includes a message handling application 114 for causing queued messages to be delivered to one or more recipients. In this regard and as described in further detail below with reference to FIG. 1B, the message handling application 114 can include a number of specialized components, such as daemons, assemblers, encoders, mail senders, and the like. In accordance with one embodiment, a component of the message handling application 114 polls the message request queue 110 to determine whether a new message request exists. In instances when a message request exists, the message handling application 114 coordinates the transmission of messages to individual recipients using specialized components that construct, encode, and eventually cause the messages to be transmitted. The functionality of those components of the message handling application 114 will be described in further detail below.

As further illustrated in FIG. 1A, the processing performed by the message handling application 114 may be distributed across the handling servers 118. Similar to the description provided above with reference to the messaging servers 116, the handling servers 118 may include a number of different types of servers that facilitate receipt of communications using a variety of communication media. In an illustrative embodiment, the handling servers 118 can be arranged in a peer-to-peer networking environment such that each successive server is operable to replicate the functionality of the previous server. In accordance with an embodiment, in the event that one of the handling servers 118 is called upon to process a higher volume of messages or, in the event of a server failure, another server can take over all or at least a portion of the other server's role in the online service 106.

Now with reference to FIG. 1B additional description of certain components that may be included in the online service 106 will be described in additional detail. As illustrated in FIG. 1B, the online service 106 includes a client interface application 108, a message request queue 110, a user data repository 112, and a message handling application 114.

In accordance with one embodiment, the client interface application 108 includes a message application programming interface (“API”) 150 and a plurality of client request daemons including a reminder daemon 152, a calendar-digest periodical daemon 154, and an update daemon 156. Requests to create and satisfy a message job may be generated from one or more messaging clients 102 (FIG. 1A) in different ways. For example, the software application 104 may cause data to be stored in the user data repository 112 in order to send a new message. In this instance, the client request daemons 152, 154, and 156 operating in association with the client interface application 108 poll (periodically or continuously) the user data repository 112 for data that is characteristic of a new request. When a request to send a new message is identified, the appropriate client request daemon 152, 154, or 156 causes data received in the request to be “enqueued” in the message request queue 110. When enqueued, a request is available to the message handling application 114 so that the request may be satisfied. In this instance, requests to send a message are generated asynchronously from the satisfaction of the request by the online service 106. By uncoupling request generation from the processing performed to satisfy the request, aspects of the present invention allow requests to be generated even when certain components provided by the online service 106 are not available. Those skilled in the art and others will recognize the uncoupling of request generation from the processing performed to satisfy requests results in a more resilient messaging architecture than traditional systems. For example, the handling servers 118 may be temporarily unavailable and unable to perform processing to satisfy a request. However, in this instance, since the request data is available from the user data repository 112, the request may be satisfied when the handling servers 118 become available. In another embodiment, the software application 104 may generate a request to send a mail message by issuing an API call to the message API 150. When the appropriate API call is received, the message API 150 causes data received in the request to be “enqueued” in the message request queue 110. In this instance, requests to send a message are generated synchronously with the processing that satisfies the request.

When a request to send a message is received by either the message API 150 or a client request daemon, such as the daemons 152, 154, or 156, processing is performed to enqueue data in the message request queue 110. The data enqueued by components of client interface application 108 can include various information for a message, such as the number of recipients, processing instructions (e.g., compression, encryption, etc.), delivery timing, delivery mechanisms, and the like. Moreover, the content that is transmitted as a result of a request may be of different types including, but not limited to reminders that describe an upcoming event, periodical newsletters, updates made to a calendar item, and the like.

In one embodiment, the process of enqueuing data in the message request queue 110 includes serializing, prioritizing, and/or classifying a request. Those skilled in the art and others will recognize that serialization refers to the processing performed in preparation for transmitting an object, such as an object created from an object oriented class, across a communication link. Serialization of an object allows aspects of the present invention to compactly transmit data to the request queue 110 in a way that allows the object to be de-serialized or recreated at a subsequent point in time. The classification of a request performed by components of the client interface application 108 may be identified automatically. For example, a plurality of client request daemons, such as the request daemons 152, 154, and 156 are provided that identify different types of requests. In accordance with one embodiment, requests may be classified based on which client request daemon 152, 154, or 156 identified a request. By way of another example, the message API 150 is configured to satisfy various function calls for generating requests. In this instance, requests may be classified based on which API call was made from the software application 104. The prioritization of a request performed by components of the client interface application 108 are configurable to satisfy the needs of a user and/or the messaging architecture. For example, a user that generated a request from the software application 104 may designate a priority for satisfying the request. Alternatively, the messaging architecture may prioritize requests based on the needs of the online service 106.

In accordance with one embodiment, the message request queue 110 and the user data repository 112 are each implemented as a shared network resource. As a result, message requests may be stored in the user data repository 112 and/or enqueued in the message request queue 110 from any remote computing device/process that has the appropriate permissions. Moreover, the message request queue 110 may be collectively implemented in multiple destination queues that are physically located on different computing devices. For example, mailer daemons that execute on different physical computing devices, such as the handling servers 118 may be configured to initiate the process of satisfying different types of requests. In this embodiment, the request is routed to the appropriate computing device and stored in a destination queue based on how the request is classified. A mailer daemon that is configured to initiate the process of satisfying the type of request in the individual destination queue executes on the computing device where the request is routed. In this embodiment, a plurality of destination queues collectively implement the request queue 110 across a distributed set of computing devices (e.g., message handling servers 118).

As illustrated in FIG. 1B, the message handling application 114 includes the “MESSAGE SERVICE PROCESS A” 158 and a “MESSAGE SERVICE PROCESS B” 160. Generally described, message service processes access resources to satisfy a request represented in the message request queue 110. In this regard, the processing application 114 is configured to support multiple processes (e.g., the “MESSAGE SERVICE PROCESS A” 158, the “MESSAGE SERVICE PROCESS B” 160, etc.) with each process executing on a separate computing device. The different processes created by the message handling application 114 may each satisfy different types of requests. Those skilled in the art and others will recognize that a messaging architecture in which processes execute on separate computing devices should be construed as exemplary as other configurations are possible. However, the messaging architecture implemented by aspects of the present invention in which processes execute on separate computing devices enables a high volume of requests to be satisfied. Moreover, this configuration provides a way to easily “load balance” the processing performed by aspects of the present invention.

As illustrated in FIG. 1B, the “MESSAGE SERVICE PROCESS A” 158 includes the mailer daemons 162, 164, and 166. Similarly, the “MESSAGE SERVICE PROCESS B” includes the mailer daemons 168, 170, and 172. In accordance with one embodiment, each of the message service processes 158 and 160 execute mailer daemons as separate threads. Synchronization and coordination of the separate threads within the message service processes is accomplished with the use of a daemon controller (not illustrated). Generally described, the mailer daemons 162, 164, 166, 168, 170, and 172 are responsible for obtaining data from the message request queue 110. In this regard, the mailer daemons 162, 164, 166, 168, 170, and 172 (1) poll the message request queue 110 for new message requests; (2) de-serialize any identified requests; (3) remove any identified requests from the message request queue 110, when appropriate; and (4) create message jobs to satisfy each request.

In accordance with one embodiment, after identifying a request, one of the mailer daemons 162, 164, 166, 168, 170, or 172 causes processing implemented by the online service 106 to continue by creating an appropriate “message job.” For illustrative purposes, the online service 106 depicted in FIG. 1B depicts a message job 174 that was created by the mailer daemon 168. Generally described, the message job 174 implements functionality to (1) obtain content that will be included in a message; (2) use the message assemblers 176, 178, 180 to construct one or more messages; (3) use the message encoders 182, 184, and 186 to prepare a message for transmission to a remote computing device; and (4) use the message senders 188, 190, and 192 to transmit the messages over a communications link. Moreover, aspects of the present invention perform logging functionality that identifies a job's status, type, content, and the like. This information may be recalled while the message job is executing or sometime thereafter to determine, for example, whether a request was satisfied. Those skilled in the art and others will recognize that that FIG. 1B is a highly simplified example that depicts the components of an exemplary online service 106 capable of implementing aspects of the present invention.

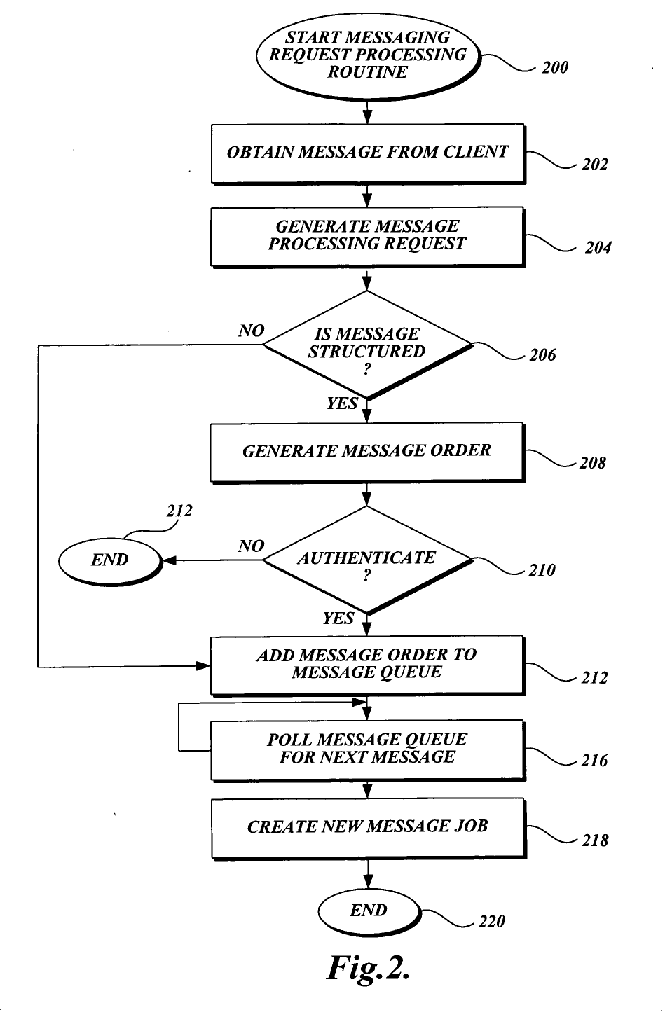

As described above, in an actual embodiment of the present invention, a user action within a Web application associated with the online service 106 synchronously produces a message order that is delivered by the online service 106 over a communications network. FIG. 2 is flow diagram of an illustrative message request processing routine 200 implemented by the online service 106 in accordance with an aspect of the present invention. At block 202, the online service 106 obtains client requests for processing a message from one or more messaging clients 102. In an illustrative embodiment, the client requests can correspond to electronic mail messages with various types of content, including text, graphics, multi-media content, meeting requests, processing instructions, etc. The client requests can also include various processing information, such as the number of recipients, additional processing instructions (e.g., compression, encryption, etc.), delivery timing, delivery mechanisms, and the like.

At block 204, a message request is generated in response to the client request within a software application 104. At block 206, the online service 106 determines whether the software application 104 message request corresponding to the client request is a generic or structured message request. If the message request is a generic message, the routine 200 proceeds to block 214, which will be described in greater detail below. If the message request is a structured message request, at block 208, the client interface application 108 of the online service 106 generates a message order corresponding to all incoming messages from the specific software application 104 and/or software applications 104. At decision block 210, a test is conducted to determine whether the user data repository 112 authenticates the message according to message order IDs. If the message cannot be authenticated, the routine 200 terminates at block 212.

If at decision block 210 the message order data is authenticated or if the message is generic, at block 214, the message order is added to the message request queue 110. In an illustrative embodiment, details concerning the message order can be stored in a message request queue table (Table 1).

TABLE 1
MESSAGE REQUEST QUEUE TABLE

Message_ID Unique number assigned to each message
Submitter_ID: Unique number identifying a user
Recipient_IDs: Unique numbers identifying a recipients
Message_Body:
Message_Type:
Message_Status:

In one embodiment, the process of enqueuing the order at block 214 may include serializing, prioritizing, and/or classifying data obtained in a request. Serialization provides a way for aspects of the present invention to compactly transmit data and allow the state of an object to be recreated at a later point in time. The classification of a request may be identified automatically based on which client request daemon 152, 154, or 156 identified data indicative of a new request. The prioritization of a request may be based on input obtained from a user on aspects of the present invention may prioritize requests based on the needs of the online service 106.

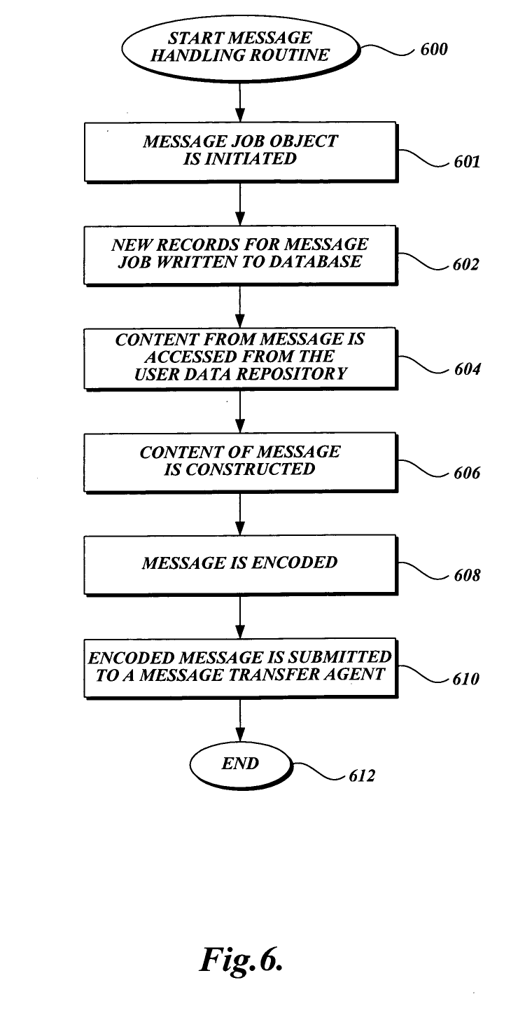

At block 216, a mailer daemon, such as the mailer daemon 168, polls the message request queue 110 for pending requests as determined by the existence of an active message in the message status field. If no message is found, after a system-defined delay, the message request queue 110 is again polled. As mentioned previously and in accordance with one embodiment, mailer daemons implemented in a multi-threaded-environment may poll the message request queue 110 for new messages at block 216. When a new message is identified, a mailer daemon removes the request from the message request queue 110. Then, at block 218, a new message job is created so that the message may be delivered to the intended recipient(s). In one aspect, the mailer daemon identifies which message job to create at block 218 by using data in the message_type field in Table 1. Based on the data stored in this field, the mailer daemon is able to match the type of request that was received with a message job that is configured to satisfy the received request. Then the message request processing routine 200 proceeds to block 220, where it terminates. As described in further detail below with reference to FIG. 6, additional processing will be performed by aspects of the present invention once a message job has been created so that the messages may be transmitted to the intended recipients.

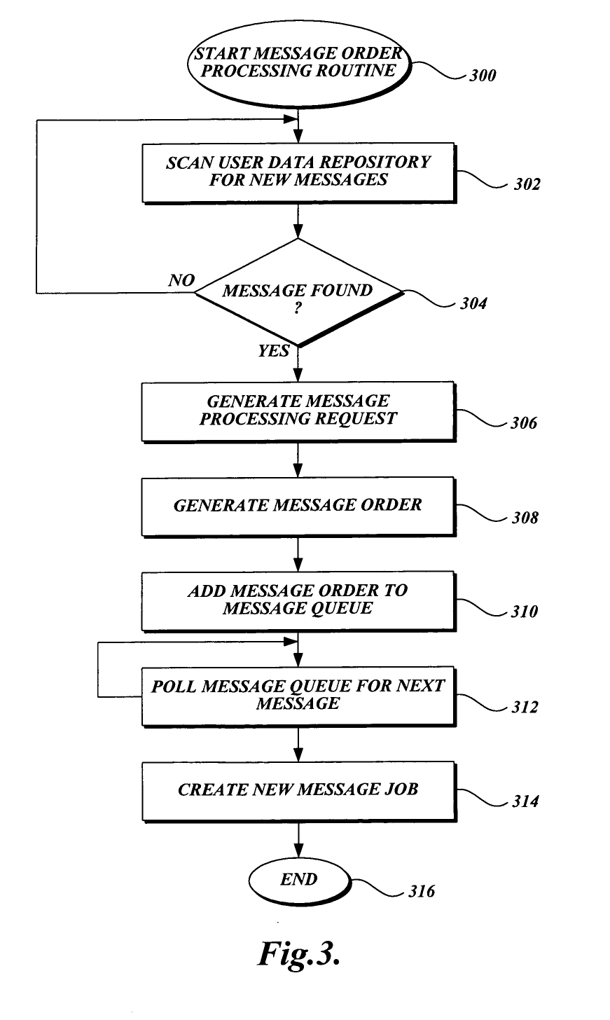

Utilizing the messaging architecture, the online service 106 can also support a user action within a Web application associated with the online service 106 that asynchronously produces a message order that is delivered by the online service 106 over a communications network. FIG. 3 is flow diagram of an illustrative message order processing routine 300 implemented by the online service 106 in accordance with this aspect of the present invention. At block 302, a client request daemon operating in association with the client interface application 108 of the online service 106 (periodically or continuously) scans the user data repository 112 for new message data. As mentioned previously, requests may be generated asynchronously from the satisfaction of the request by the online service 106. By uncoupling request generation from the processing performed to satisfy a request, aspects of the present invention allow requests to be received even when certain components provided by the online service 106 are not available.

At block 304, a test is conducted to determine whether any new requests are found. If not, the routine 300 returns to block 302. If new messages are found, at block 306 the appropriate client request daemon corresponding to the client interface application 108 generates a message request. In an illustrative embodiment, the message request generated by the client request daemon is an email message request. At block 308, an email order is generated. The message order includes submitter (user account) id, list of recipient ids, and a message body (information identifying the type of request).

At block 310, the message order is added to the message request queue 110. In an illustrative embodiment, details concerning the message order can be stored in a message request queue table. Moreover, similar to the description provided above, the process of enqueuing data at block 310 may include serializing, prioritizing, and/or classifying data in the received request.

In an illustrative embodiment, at block 312, a mailer daemon obtains an email order by polling the message request queue 110 for pending requests. As mentioned previously and in accordance with one embodiment, mailer daemons implemented in a multi-threaded environment may poll the message request queue 110 for new messages. When a new message is identified, the mailer daemon that identified the request removes the request from the message request queue 110. Then, at block 314, execution of a new message job is initiated so that the messages may be delivered to the intended recipients. Then the routine 300 proceeds to block 316, where it terminates. As described in further detail below with reference to FIG. 6, additional processing will be performed by aspects of the present invention once a message job has been created so that a request may be satisfied.

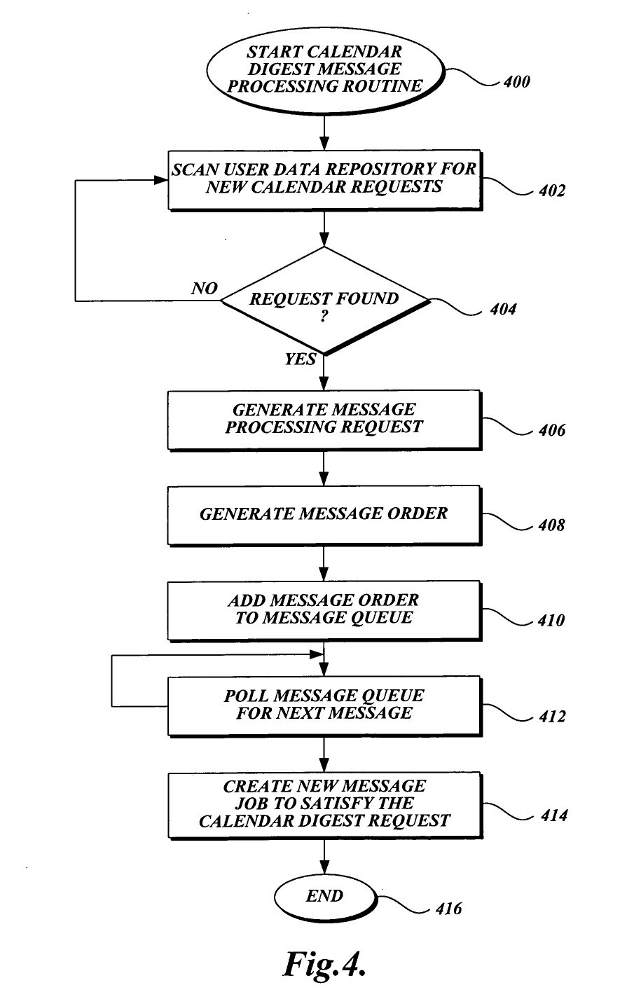

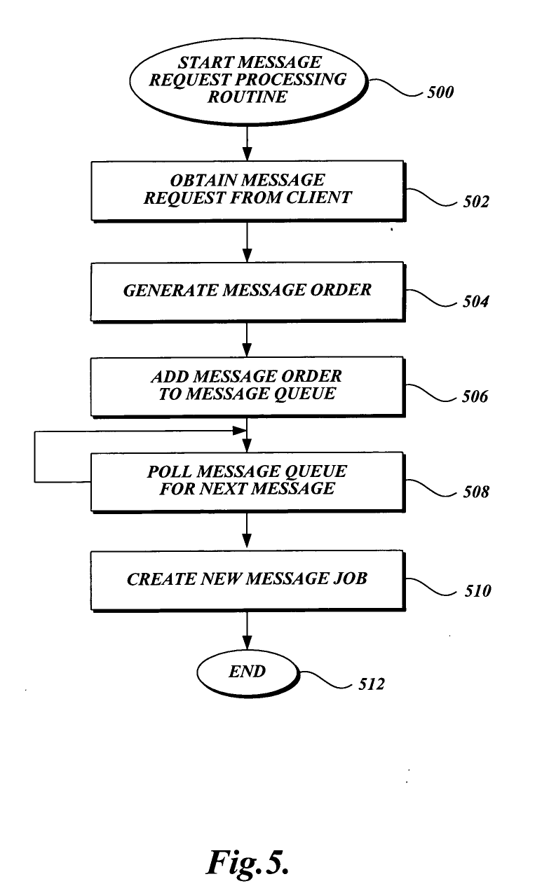

The following description provided with reference to FIGS. 4 and 5 includes two illustrative embodiments of the use of a messaging architecture for an online service. In the first embodiment, an online service is provided for management and distribution of time-related data. In this embodiment, the online service 106 provides the software applications 102 for scheduling, calendaring, event planning, and the like. Calendar and schedule data is stored in user data repository 112. Users of the online service can either push data to additional users/applications using the messaging architecture or pull data from the online service 106 using the messaging architecture. In an alternative embodiment, the software application 102 may also access data through a Web page that may be public or permissions-based. For example, a user of an online calendaring application may wish to receive a scheduled message detailing events for a given time period—a pull example. Alternatively, the user might wish to receive an SMS, voice, or other message with data containing a summary of a daily or weekly schedule. The summary of events might include data from one or more calendars associated with one or more users. The resulting digest of time-related event data could be distributed to one or more users in various formats for customized delivery and display.

FIG. 4 is flow diagram of an illustrative message order processing routine 400 implemented by the online service 106 in accordance with the calendar digest illustration. At block 402, a calendar-digest periodical daemon 154 operating in association with the online service 106 (periodically or continuously) scans the user data repository 112 for calendar digest data. At block 404, a determination is made regarding whether a new message request was found. In an illustrative embodiment, the message request generated by the calendar-digest periodical daemon 154 is an email message request. At block 406, an email message processing request is generated. The message request includes submitter (user account) id, list of recipient ids, and a message body (information identifying the type of request).

At block 408, the calendar-digest message order is added to the message request queue 110. In an illustrative embodiment, orders are processed using time parameters and/or priority. As illustrated in FIG. 4, at block 410, a mailer daemon associated with the message handling application 114 obtains an email order from the front of the message request queue 110 so that an email message job may be created at block 414. In this regard, a message job is instantiated for each recipient of the calendar-digest message. As will be described in further detail below with reference to FIG. 6, the necessary data used to construct the email messages and satisfy the calendar digest message request is obtained from the user data repository 112. In an illustrative embodiment, the message handling application 114 utilizes a mailer daemon, assembler, encoder, and sender that are configured to identify and construct the calendar-digest message. However, upon the message handling application 114 obtaining the email order from the front of the message request queue 110 and creating a message job, the routine 400 proceeds to block 416, where it terminates.

In the second illustrative embodiment, an online service is provided for management and distribution of digital image data. In this embodiment, the online service 106 provides the software application 102 for storing, printing, modifying, and distributing digital images. Image data is stored in user data repository 112. Users of the online service 106 can either push digital image data to additional users/applications using the messaging architecture or pull data from the online service 106 using the messaging architecture. For example, a user of an online digital image management application may wish to send a digital image to another user or application—a push example.

FIG. 5 is flow diagram of an illustrative message request processing routine 500 implemented by the online service 106 in accordance with the digital image management illustration. At block 502, a message request is generated in response to a user action within a software application 102. For example, a user might select an option to “send photo.” Additionally, the user can identify or select one or more recipients to receive the digital image data. In an illustrative embodiment, recipient data is stored in the user data repository 112. At block 504, a message order is generated. At block 506, the message order is added to the message request queue 110. In an illustrative embodiment, message requests are processed using time parameters and/or priority.

As illustrated in FIG. 5, at block 508, a component of the message handling application 114 obtains an email order from the front of the message request queue 110 so that an email message job may be created at block 510. As will be described in further detail below with reference to FIG. 6, the necessary data used to construct the message is accessed from the user data repository 112. In an illustrative embodiment, the message handling application 114 utilizes a mailer daemon, assembler, encoder, and sender to construct the message that will be transmitted to the recipients. However, upon the message handling application 114 obtaining the digital image order from the front of the message request queue 110, the routine 500 proceeds to block 512, where it terminates.

Now with reference to FIG. 6, a message handling routine 600 will be described that is configured to satisfy a request to transmit a message received by the online service 106. As mentioned previously, aspects of the present invention receive requests for sending various types of messages over a messaging architecture. When a request is received, processing is performed to enqueue data in the message request queue 110. Generally described, the handling routine 600 may be implemented in conjunction with any of the routines 200-500 described above with reference FIGS. 2-5. In this regard, once a message has been identified and accessed from the message request queue 110, the routine 600 coordinates the transmission of messages to individual recipients using various components to construct, encode, and communicate the message to a remote computing device.

As illustrated in FIG. 6, the handling routine 600 begins at block 602 where a message job object is instantiated. As mentioned previously, mailer daemons, such as the mailer daemons 162, 164, 166, 168, 170, and 172 (FIG. 1B) are responsible for obtaining data from the message request queue 110. These mailer daemons poll the message request queue 110 for new message requests and instantiate a message job at block 602 that is configured to satisfy the received request.

In accordance with one embodiment, once a message job is instantiated, new records associated with the job are written to the user data repository 112, at block 604. As mentioned previously, aspects of the present invention may record and recall information associated with a message job including the jobs' status, type, content, and the like. This information is identified and recorded in the user data repository 112, at block 604. Moreover, as the message handling routine 600 performs additional steps to satisfy a request, each step performed is also reflected in the user data repository 112. Finally, for each of the recipients specified to receive the message, a drop record is added to the user data repository 112 that indicates, among other things, whether the message was delayed, blocked, bounced, etc. This information that describes a message job may be recalled while the message job is executing or sometime thereafter to determine, for example, whether a message was successfully handled.

At block 606, content associated with the message being created is accessed from the user data repository 112. The data accessed from the user data repository 112 may be in any number of different formats. For example, text and hypertext, digital images, calendar objects, and the like make be accessed from the user data repository 112 and used to create a message. In this regard, if the received request dictates that the message be customized to each individual recipient, the recipients name may be obtained from the user data repository 112 at block 606. Similarly, if the message is an update to event that is tracked by a calendaring application, the data obtained at block 606 may be a calendar item that will be attached to the message. However, those skilled in the art and others will recognize that the examples provided above should be construed as exemplary as other data may be obtained at block 606 without departing from the scope of the claimed subject matter.

At block 608, the actual content of the message is constructed using a message assembler. As mentioned previously, various message assemblers are provided by aspects of the present invention for constructing different types of message. For example, a calendar-digest message assembler may be used to construct a message with calendar digest information. In this instance, a message that contains a summary of one or more users' schedule over a given period of time is constructed using data obtained at block 606. By way of another example, a generic message assembler that constructs and caches an identical message for transmission to a plurality of users may be utilized at block 608. Moreover, message assemblers that construct reminder messages, calendar updates, and the like are also contemplated for use by aspects of the present invention. To determine which message assembler to call, the handling routine 600 accesses data stored in the message request queue 110 to identify the type of message that will satisfy the request. Then, based on message type, a message assembler that is configured to create the appropriate message is called. In the embodiment in which the message being transmitted is an email, the message assembler is responsible for creating content that adheres to particular formats. For example, a message assembler may create an email that contains both text and HyperText Markup Language (“HTML”) formatted data, at block 608.

Once the appropriate assembler is called and the content is fully assembled, the message is encoded, at block 610, into a format that is suitable for the transmission protocol that will be used to send the message. For example, since many email clients and Web browsers support the Multipurpose Internet Mail Extension (“MIME”) protocol, the message may be encoded into the MIME format at block 610. However, other encoders that are configured to perform processing so that a message may be transmitted using a different transmission protocol may be called at block 610 without departing from the scope of the claimed subject matter. Then, at block 612, a message sender object is instantiated that submits the encoded message to a message transfer agent. For example, a message sender object may be instantiated at block 612 that is configured to send an encoded email message to an SMTP agent for delivery. Similarly, a message sender object may be instantiated at block 612 that is configured to send a text message using a Short Message Service (“SMS”) agent for delivery. The use of SMTP and SMS agents is well known to those skilled in the art of message delivery systems and will not be described in further detail here. Then, the handling routine 600 proceeds to block 614, where it terminates.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. In a networking environment that includes a client computing device communicatively connected to an online service, a method for processing a request to transmit a message, the method comprising:
obtaining a message request from a client computing device;
generating a queue of message requests, wherein the queue of message requests identifies an order of message processing;
processing the queue of message requests to determine the next message; and
transmitting messages until the message queue is complete.

2. The method as recited in claim 1, wherein obtaining a message request from a client computing device is performed asynchronously from processing the queue of message requests to determine the next message.

3. The method as recited in claim 2, wherein obtaining a message request from a client computing device, includes:
storing the message request data in a repository; and
polling the repository to determine whether a new request has been received.

4. The method as recited in claim 1, wherein obtaining a message request from a client computing device is performed synchronously with processing the queue of message requests to determine the next message.

5. The method as recited in claim 1, wherein obtaining a message request from a client computing device includes using a calendar digest daemon to identify a set of events that are scheduled to occur in a given period of time.

6. The method as recited in claim 1, wherein the messages transmitted are email messages; and
wherein processing the queue of message requests includes generating content for the messages that contains both text and HTML formatted data.

7. The method as recited in claim 1, wherein generating a queue of message requests includes serializing, prioritizing, and classifying the requests.

8. The method as recited in claim 1, wherein transmitting messages until the message queue is complete includes deserializing data stored in the queue and creating a message job object that is configured to satisfy the request.

9. The method as recited in claim 1, wherein transmitting messages until the message queue is complete includes providing a plurality of message assemblers for constructing different types of messages.

10. The method as recited in claim 9, wherein transmitting messages until the message queue is complete, includes:
using a message encoder to convert the messages into a format suitable for the transmission protocol that will used to transmit the message; and
submitting the encoded message to a message transfer agent.

11. A system for transmitting messages in a networking environment in response to receiving a request, the system comprising:
one or more client computing devices including at least one software application for facilitating communication over a communication network; and
a message processing service including a client interface component for obtaining communications from the one or more client computing devices and generating message requests in a queue and a message handling component for handling the message requests from the queue for delivery to the one of more client computing devices.

12. The system as recited in claim 11, further comprising a repository component operative to store request data that enables the message handling component to deliver messages asynchronously from the client interface component generating the message requests.

13. The system as recited in claim 11, wherein the queue is implemented as a shared network resource that may be accessed when the message handling component is unavailable.

14. The system as recited in claim 12, wherein the client interface component includes a plurality client request daemons that each identify a different type of request.

15. The system as recited in claim 12, wherein the messages transmitted by the message processing service includes time related data maintained by a calendaring application.

16. The system as recited in claim 12, wherein the message handling component is configured to balance the load of transmitting a plurality of messages by generating multiple processes that each execute on a separate computing device.

17. The system as recited in claim 12, wherein each process generated by the message handling component generates a plurality of threads that each execute a different mailer daemon.

18. A computer-readable medium having computer executable components for processing messages, comprising:
a client interface component for obtaining messages from client computing devices and generating a queue of message requests, wherein each message corresponds to a defined communication medium; and
a message handling component for processing the queue of message requests to transmit a series of messages in accordance with processing instructions.

19. The computer-readable-medium as recited in claim 18, wherein the client interface component includes:
assembler components that construct different types of messages based on the processing instructions; and
encoder components that convert the messages into a format suitable for transmission over the communication medium.

20. The computer-readable-medium as recited in claim 18, wherein the message handling component is configured to transmit a series of customized messages that are customized to each recipient in accordance with the processing instructions.
